(19) United States
(12) Patent Application Publication
(10) Pub. No.: US 2014/0267953 A1
(43) Pub. Date: Sep. 18, 2014

(54) TOUCH SCREEN PANEL AND METHOD OF MANUFACTURING THE SAME

(71) Applicant: Samsung Display Co., Ltd., Yongin-City (KR)

(72) Inventors: Jung-Hyun KIM, Yongin-City (KR); Sung-Ki JUNG, Yongin-City (KR); Chung-Soo HA, Yongin-City (KR); Young-Sam SEO, Yongin-City (KR)

(21) Appl. No.: 14/202,310

(22) Filed: Mar. 10, 2014

(30) Foreign Application Priority Data
Mar. 14, 2013 (KR) 10-2013-0027564

(51) Int. Cl. G06F 1/16

(52) U.S. Cl. CPC G06F 1/169
USPC 349/12; 427/97.3

(57) ABSTRACT

In a method of manufacturing a touch screen panel, first sensing electrodes are formed in an active area of a substrate and are connected in a first direction, and second sensing electrodes are connected in a second direction that intersects the first direction. The method includes forming outside wiring lines for connecting the first and second sensing electrodes to an external driving circuit in units of lines in a non-active area positioned outside an active area of the substrate, forming bridge patterns for electrically connecting the first sensing electrodes in the active area of the substrate, forming insulating layer patterns for insulating the second sensing electrodes and the bridge patterns from each other on the bridge patterns, and forming the first and second sensing electrodes on the substrate where the outside wiring lines, the bridge patterns, and the insulating layer patterns are formed.

### CLAIM OF PRIORITY

This application makes reference to, incorporates into this specification the entire contents of, and claims all benefits accruing under 35 U.S.C. §119 from an application earlier filed in the Korean Intellectual Property Office on Mar. 14, 2013 and there duly assigned Serial No. 10-2013-0027564.

### BACKGROUND OF THE INVENTION

1. Field of the Invention

The present invention relates to a touch screen panel and a method of manufacturing the same.

2. Description of the Related Art

A touch screen panel is an input device capable of selecting an indication content displayed on a screen of an image display device by a human hand or by an object to input a command of a user.

Therefore, the touch screen panel is provided on a front face of the image display device to convert a contact position of the human hand or the object into an electrical signal. Therefore, the indication content selected in the contact position is received as an input signal.

The touch screen panel is commonly attached to an external surface of the image display device, such as a liquid crystal display (LCD) and an organic light emitting display (OLED) to be produced. Therefore, the touch screen panel requires high transparency and thin film characteristics.

In addition, recently, a flexible image display device is being developed. In this case, the touch screen panel attached to the flexible image display device also requires a flexible characteristic.

### SUMMARY OF THE INVENTION

The present invention relates to a touch screen panel capable of preventing sensing electrodes from being damaged during etching and a method of manufacturing the same.

In an aspect of the present invention, there is provided a method of manufacturing a touch screen panel including first sensing electrodes connected in a first direction and second sensing electrodes connected in a second direction intersecting the first direction, the first and second electrodes being in an active area of a substrate. The method includes forming outside wiring lines for connecting the first and second sensing electrodes to an external driving circuit in units of lines in a non-active area outside an active area of the substrate, forming bridge patterns for electrically connecting the first sensing electrodes in the active area of the substrate, forming insulating layer patterns for insulating the second sensing electrodes and the bridge patterns from each other on the bridge patterns, and forming the first and second sensing electrodes on the substrate where the outside wiring lines, the bridge patterns, and the insulating layer patterns are formed.

Forming the outside wiring lines may include depositing a metal conductive layer on the substrate and patterning the metal conductive layer. Forming the bridge patterns may include coating a first nanowire conductive layer on the substrate and patterning the first nanowire conductive layer. The bridge patterns may be formed in the same layer as the outside wiring lines.

Forming the insulating layer patterns may include depositing an insulating layer on the substrate where the bridge patterns are formed, and patterning the insulating layer. The insulating layer patterns may partially overlap the bridge patterns.

The insulating layer patterns may be shorter than the bridge patterns in the first direction and longer than the bridge patterns in the second direction.

The bridge patterns and the insulating layer patterns may be positioned at intersections of the first and second sensing electrodes.

Forming the first and second sensing electrodes may include coating a second nanowire conductive layer on the substrate where the outside wiring lines, the bridge patterns, and the insulating layer patterns are formed, and patterning the second nanowire conductive layer. The first and second nanowire conductive layers may comprise a material including AgNW.

The method may further include patterning at least one of the first and second nanowire conductive layers to form second outside wiring lines that overlap the outside wiring lines.

In forming the first and second sensing electrodes, connecting patterns for connecting the second sensing electrodes in the second direction may be formed together.

The first sensing electrodes may be formed so as to overlap both ends of the bridge patterns.

The substrate may be a thin film substrate of at least one selected from the group consisting of polyethylene terephthalate (PET), polycarbonate (PC), acryl, polymethylmethacrylate (PMMA), triacetyl cellulose (TAC), polyethersulfone (PES), and polyimide (PI).

According to another embodiment of the present invention, there is provided a method of manufacturing a touch screen panel including first sensing electrodes connected in a first direction and second sensing electrodes connected in a second direction intersecting the first direction, the first and the second sensing electrodes being in an active area of a substrate. The method includes forming a metal conductive layer in a non-active area positioned outside an active area of the substrate, forming bridge patterns for electrically connecting the first sensing electrodes in the active area of the substrate, forming insulating layer patterns for insulating the second sensing electrodes and the bridge patterns from each other on the bridge patterns, and forming the first and second sensing electrodes on the substrate where the metal conductive layer, the bridge patterns, and the insulating layer patterns are formed.

Forming the bridge patterns may include coating a first nanowire conductive layer on the substrate and patterning the first nanowire conductive layer. Forming the insulating layer patterns may include depositing an insulating layer on the substrate where the bridge patterns are formed and patterning the insulating layer. Forming the first and second sensing electrodes may include coating a second nanowire conductive layer on the substrate where the metal conductive layer, the bridge patterns, and the insulating layer patterns are formed, and patterning the second nanowire conductive layer. The first and second nanowire conductive layers may comprise a material including AgNW.

The method may further include forming outside wiring lines for connecting the first and second sensing electrodes to an external driving circuit in units of lines in the non-active area.

In forming the outside wiring lines, the metal conductive layer, the first nanowire conductive layer, and the second nanowire conductive layer sequentially laminated in the non-active area may be simultaneously patterned to form the outside wiring lines.

The outside wiring lines may be simultaneously formed with the first and second sensing electrodes through the same process.

There is provided a touch screen panel, including a substrate divided into an active area and a non-active area positioned outside the active area, first sensing electrodes connected in a first direction and second sensing electrodes connected in a second direction intersecting the first direction, the first and second sensing electrodes being in an active area of a substrate, bridge patterns for electrically connecting the first sensing electrodes in the first direction, insulating layer patterns for insulating the second sensing electrodes and the bridge patterns from each other, and outside wiring lines for connecting the first and second sensing electrodes to an external driving circuit in units of lines. The first and second sensing electrodes are formed on the substrate where the outside wiring lines, the bridge patterns, and the insulating layer patterns are formed.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components.

In the drawing figures, dimensions may be exaggerated for clarity of illustration. It will be understood that, when an element is referred to as being “between” two elements, it can be the only element between the two elements, or one or more intervening elements may also be present. Like reference numerals refer to like elements throughout.

FIG. 1A is a plan view schematically illustrating a touch screen panel according to an embodiment of the present invention;

FIG. 1B is a sectional view obtained by taking the touch screen panel of FIG. 1A along a first direction;

FIGS. 2A to 2I are views describing a method of manufacturing the touch screen panel; and

FIG. 3 is a sectional view of a touch screen panel according to another embodiment of the present invention.

### DETAILED DESCRIPTION OF THE INVENTION

Hereinafter, the embodiments of the present invention will be described in detail with reference to the accompanying drawings.

FIG. 1A is a plan view schematically illustrating a touch screen panel according to an embodiment of the present invention, and FIG. 1B is a sectional view obtained by taking the touch screen panel of FIG. 1A along a first direction.

Referring to FIGS. 1A and 1B, a touch screen panel according to an embodiment of the present invention may include a substrate 10, sensing electrodes 11, connecting patterns 11c, insulating patterns IP, bridge patterns BP, and outside wiring lines 15.

The substrate 10 may be divided into an active area AA that overlaps an image display area and in which the sensing electrodes 11 are formed on one surface so that a touch input may be performed, and a non-active area NA that is positioned outside the active area AA and in which the outside wiring lines 15 are formed.

Here, the non-active area NA as a light shielding area that overlaps an image non-display area of the display unit 30 surrounds the active area AA in which an image is displayed.

The substrate 10 may be formed of a flexible and transparent material having high thermal and chemical resistance, and may be a thin film substrate formed of at least one selected from the group consisting of, for example, polyethylene terephthalate (PET), polycarbonate (PC), acryl, polymethylmethacrylate (PMMA), triacetyl cellulose (TAC), polyethersulfone (PES), and polyimide (PI).

The sensing lines 11 may include a plurality of first sensing electrodes 11a arranged to be dispersed in the active area AA on the substrate 10, and which are electrically connected to each other in a first direction D1, and second sensing electrodes 11b which are arranged to be dispersed between the first sensing electrodes 11a so as not to overlap the first sensing electrodes 11a, and which are electrically connected to each other in a second direction D2 that intersects the first direction D1.

That is, the first sensing electrodes 11a and the second sensing electrodes 11b are alternately arranged so as to be connected in different directions. For example, the first sensing electrodes 11a may be formed so as to be connected in a row direction (a horizontal direction) and may be connected to the wiring lines 15, respectively, in units of row lines, and the second sensing electrodes 11b may be formed so as to be connected in a column direction (a vertical direction) and may be connected to the wiring lines 15, respectively, in units of column lines.

The first sensing electrodes 11a and the second sensing electrodes 11b may be formed of a material including AgNW with improved electrical and flexible characteristics, and may be diamond-shaped and arranged in the same layer.

The material of the sensing electrodes 11 is not limited to AgNW but the sensing electrodes 11 may be formed of a transparent electrode material so as to transmit light from a display panel (not shown) arranged under the sensing electrodes 11.

In addition, in another embodiment, the sensing electrodes 11 may be stripe-shaped, and a material, a shape and an arrangement structure of the sensing electrodes 11 may have various modifications.

The connecting patterns 11c connect the second sensing electrodes 11b in the second direction D2 and the bridge patterns BP connect the first sensing electrodes 11a in the first direction D1.

The connecting patterns 11c are formed of patterns directly connected to the second sensing electrodes 11b, and the bridge patterns BP have patterns separated from the frit sensing electrodes 11a so as to be electrically connected to the first sensing electrodes 11a, and so as to connect the first sensing electrodes 11a in units of lines in the first direction D1.

Here, the insulating patterns IP are formed at intersections of the first sensing electrodes 11a and the second sensing electrodes 11b, that is, between the connecting patterns 11c and the bridge patterns BP so as to electrically insulate the two patterns from each other.

In the present embodiment, it is described that the connecting patterns 11c and the bridge patterns BP include AgNW together with the sensing electrodes 11. However, in another embodiment, the connecting patterns 11c and the bridge patterns BP may be formed of another transparent electrode material or a low resistance opaque metal material.

When the connecting patterns 11c are formed of the transparent electrode material, processes may be simplified by integrally patterning the second sensing electrodes 11b and the connecting patterns 11c from a step of patterning the transparent electrode material.

The bridge patterns BP may be formed of the same transparent electrode material as that of the sensing electrodes 11 and the connecting patterns 11c or the opaque low resistance metal material. A width or a thickness and a length of the bridge patterns BP may be controlled so that it is possible to prevent the bridge patterns BP from being visible.

When the bridge patterns BP are formed of the low resistance opaque metal material, processes may be simplified by simultaneously forming the bridge patterns BP and the outside wiring lines 15 in a step of forming the outside wiring lines 15 arranged in the non-active area NA. That is, the bridge patterns BP may be formed of the same material as that of the outside wiring lines 15.

The width of the bridge patterns BP is limited so that it is possible to prevent the bridge patterns BP from being visible. Therefore, the width of the bridge patterns BP may be smaller than that of the connecting patterns 11c formed of the transparent electrode material.

In another embodiment, the bridge patterns BP may be designed to be obliquely inclined so that it is possible to effectively prevent the bridge patterns BP from being visible.

The outside wiring lines 15 for connecting the first sensing electrodes 11a and the second sensing electrodes 11b to an external driving circuit (not shown) in units of lines in the first and second directions D1 and D2 are electrically connected to the first and second sensing electrodes 11a and 11b in units of row and column lines, respectively, so as to connect the first and second sensing electrodes 11a and 11b, respectively, to the external driving circuit such as a position detecting circuit through a pad unit PAD.

The outside wiring lines 15, arranged in the non-active area NA outside the touch screen panel to avoid the active area AA in which the image is displayed, may be formed of a low resistance metal material, such as Mo, Ag, Ti, Cu, Al, and Mo/Al/Mo, other than a transparent electrode material used for forming the sensing electrodes 11 since there is a wide choice of material selections.

As described above, when the sensing electrodes 11 are formed of the new material such as AgNW, the sensing electrodes 11 are damaged by an etching solution.

Therefore, according to the present invention, after forming the outside wiring lines 15 and the bridge patterns BP on the substrate 10, the sensing electrodes 11 are formed.

Therefore, it is possible to provide a touch screen panel having touch sensitivity and flexible characteristic improved by stably applying the new material such as AsNW, and a method of manufacturing the same.

The method of manufacturing the touch screen panel will be described with reference to FIGS. 2A to 2I.

FIGS. 2A to 2I are views describing a method of manufacturing the touch screen panel.

First, referring to FIGS. 2A and 2B, the outside wiring lines 15 for connecting the first and second sensing electrodes 11a and 11b to the external driving circuit in units of lines are formed in the non-active area NA positioned outside the active area AA of the substrate 10.

To be specific, a metal conductive layer MT is deposited on an entire surface of the substrate 10, and the metal conductive layer MT is patterned to form the outside wiring lines 15.

For example, a photolithography process and an etching process using a mask (not shown) in which patterns corresponding to the outside wiring lines 15 are formed may be performed on the metal conductive layer MT. At this time, the metal conductive layer MT of the active area AA is entirely removed.

Referring to FIGS. 2C and 2D, the bridge patterns BP for electrically connecting the first sensing electrodes 11a are formed in the active area AA of the substrate 10.

To be specific, a first nanowire conductive layer NW1 is coated on the entire surface of the substrate 10 and the first nanowire conductive layer NW1 is patterned to form the bridge patterns BP.

For example, a photolithography process and an etching process using a mask (not shown) in which patterns corresponding to the bridge patterns BP are formed may be performed on the first nanowire conductive layer NW1.

Here, the bridge patterns BP may be formed in the same layer as the outside wiring lines 15. In particular, when the bridge patterns BP and the outside wiring lines 15 are formed of the same material, the bridge patterns BP and the outside wiring lines 15 are simultaneously formed by the same process so that processes may be simplified.

Referring to FIGS. 2E, 2F, and 2G, the insulating patterns IP for insulating the second sensing electrodes 11b and the bridge patterns BP from each other are formed on the bridge patterns BP.

To be specific, an insulating layer IL is deposited on the entire surface of the substrate 10 where the bridge patterns BP are formed, and the insulating layer IL is patterned to form the insulating layer patterns IP.

For example, a photolithography process and an etching process using a mask (not shown) in which patterns corresponding to the insulating layer patterns IP are formed may be performed on the insulating layer IL.

Here, the bridge patterns BP and the insulating layer patterns IP are positioned at intersections of the first and second sensing electrodes 11a and 11b, respectively, and the insulating layer patterns IP may be formed to be shorter than the bridge patterns BP in the first direction D1 and to be longer than the bridge patterns BP in the second direction D2.

That is, since both ends of the bridge patterns BP must be connected to the second sensing electrodes 11b, both ends of the bridge patterns BP protrude outside the insulating layer patterns IP and, since the other areas of the bridge patterns BP must be insulated from the first sensing electrodes 11a and the connecting patterns 11c, the other areas of the bridge patterns BP must be formed to have a large width.

Referring to FIGS. 2H and 2I, the first and second sensing electrodes 11a and 11b, respectively, are formed on the substrate 10 where the outside wiring lines 15, the bridge patterns BP, and the insulating layer patterns IP are formed.

To be specific, the second nanowire conductive layer NW2 is coated on an entire surface of the substrate 10, and the second nanowire conductive layer NW2 is patterned to form the first and second sensing electrodes 11a and 11b, respectively.

For example, a photolithography process and an etching process using a mask (not shown) in which patterns corresponding to the sensing electrodes 11 are formed may be performed on the second nanowire conductive layer NW2.

At this time, the first sensing electrodes 11a must be formed to overlap both ends of the bridge patterns BP, and the connecting patterns 11c for connecting the second sensing electrodes 11b in the second direction D2 may be formed together with the first sensing electrodes 11a.

FIG. 3 is a sectional view of a touch screen panel according to another embodiment of the present invention.

The above-described disclosure may be referred to for the elements denoted by the same reference numerals as those of the above-described elements unless the disclosure is contradictory, and redundant description will be omitted.

Referring to FIG. 3, in the touch screen panel according to the present embodiment, at least one of the first and second nanowire conductive layers NW1 and NW2, respectively, is patterned to form second outside wiring lines 15a that overlap the outside wiring lines 15.

That is, at least one nanowire layer may be laminated on the outside wiring lines 15 so as to have the same shape as that of the outside wiring lines 15.

For example, when the second outside wiring lines 15a in the same layer as the first nanowire conductive layer NW1 are laminated, the bridge patterns BP and the second outside wiring lines 15a may be simultaneously formed in the same process.

Additionally, when third outside wiring lines (not shown) in the same layer as the second nanowire conductive layer NW2 are laminated, the sensing electrodes 11 and the third outside wiring lines may be simultaneously formed through the same process.

In addition, the outside wiring lines 15 and the second outside wiring lines 15a may be formed by simultaneously patterning the metal conductive layer and the nanowire conductive layer sequentially laminated in the non-active area NA of the substrate 10.

To be specific, after the metal conductive layer is formed in the non-active layer NA of the substrate 10, and the bridge patterns BP and the insulating layer patterns IP are formed in the active area AA by the above-described method, the sensing electrodes 11, the outside wiring lines 15, and the second outside wiring lines 15a may be simultaneously patterned using the same mask.

Therefore, it is possible to simultaneously form the outside wiring lines 15 and the sensing electrodes 11, and to reduce the number of patterning processes.

According to embodiments of the present invention, after the outside wiring lines and the bridge patterns are formed on the substrate, the sensing electrodes are formed so that it is possible to prevent the sensing electrodes from being damaged during an etching process of patterning the outside wiring lines and the bridge patterns.

As a result, it is possible to provide a touch screen panel having improved touch sensitivity and flexible characteristic, and a method of manufacturing the same by stably applying a new material such as AgNW.

By way of summation and review, sensing electrodes of the touch screen panel are formed of a transparent electrode material such as indium tin oxide (ITO). As new electrode materials for reducing a thickness of the touch screen panel and for improving the flexible characteristic of the touch screen panel, silver nanowires (AgNW), graphene, and conductive polymer are suggested. However, it is difficult to apply the above electrode materials to a real product.

The above new electrode materials have an extremely small thickness, and are damaged during etching when they have metal properties. For example, when the sensing electrodes are formed of AgNW and outside wiring lines and bridge patterns formed of a metal are patterned, AgNW reacts to an etching solution that removes the metal so that surface resistance is increased or conductivity is lost. Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics and/or elements described in connection with a particular embodiment may be used singly or in combination with features, characteristics and/or elements described in connection with other embodiments unless otherwise specifically indicated. Accordingly, it will be understood by those of skill in the art that various changes in form and detail may be made without departing from the spirit and scope of the present invention as set forth in the following claims.

What is claimed is:

1. A method of manufacturing a touch screen panel including first sensing electrodes connected in a first direction and second sensing electrodes connected in a second direction intersecting the first direction, the first and second sensing electrodes being in an active area of a substrate, the method comprising the steps of:
forming outside wiring lines for connecting the first and second sensing electrodes to an external driving circuit in units of lines in a non-active area outside an active area of the substrate;
forming bridge patterns for electrically connecting the first sensing electrodes in the active area of the substrate;
forming insulating layer patterns for insulating the second sensing electrodes and the bridge patterns from each other on the bridge patterns; and
forming the first and second sensing electrodes on the substrate where the outside wiring lines, the bridge patterns and the insulating layer patterns are formed.

2. The method as claimed in claim 1, wherein the step of forming the outside wiring lines comprises:
depositing a metal conductive layer on the substrate; and
forming the outside wiring lines by patterning the metal conductive layer.

3. The method as claimed in claim 2, wherein the step of forming the bridge patterns comprises:
coating a first nanowire conductive layer on the substrate; and
patterning the first nanowire conductive layer.

4. The method as claimed in claim 3, wherein the bridge patterns are formed in a same layer as the outside wiring lines.

5. The method as claimed in claim 3, wherein the step of forming the insulating layer patterns comprises:
depositing an insulating layer on the substrate where the bridge patterns are formed; and
patterning the insulating layer.

6. The method as claimed in claim 5, wherein the insulating layer patterns partially overlap the bridge patterns.

7. The method as claimed in claim 6, wherein the insulating layer patterns are shorter than the bridge patterns in the first direction and are longer than the bridge patterns in the second direction.

8. The method as claimed in claim 1, wherein the bridge patterns and the insulating layer patterns are positioned at intersections of the first and second sensing electrodes.

9. The method as claimed in claim 3, wherein the step of forming the first and second sensing electrodes comprises:
coating a second nanowire conductive layer on the substrate where the outside wiring lines, the bridge patterns, and the insulating layer patterns are formed; and
patterning the second nanowire conductive layer.

10. The method as claimed in claim 9, wherein the first and second nanowire conductive layers comprise a material including AgNW.

11. The method as claimed in claim 9, further comprising the step of patterning at least one of the first and second nanowire conductive layers to form second outside wiring lines that overlap the outside wiring lines.

12. The method as claimed in claim 1, wherein the step of forming the first and second sensing electrodes comprises forming connecting patterns which are formed together for connecting the second sensing electrodes in the second direction.

13. The method as claimed in claim 1, wherein the first sensing electrodes overlap both ends of the bridge patterns.

14. The method as claimed in claim 1, wherein the substrate is a thin film substrate of at least one selected from the group consisting of polyethylene terephthalate (PET), polycarbonate (PC), acryl, polymethylmethacrylate (PMMA), triacetyl cellulose (TAC), polyethersulfone (PES), and polyimide (PI).

15. A method of manufacturing a touch screen panel including first sensing electrodes connected in a first direction and second sensing electrodes connected in a second direction intersecting the first direction, the first and second sensing electrodes in an active area of a substrate, the method comprising the steps of:
forming a metal conductive layer in a non-active area outside an active area of the substrate;
forming bridge patterns for electrically connecting the first sensing electrodes in the active area of the substrate;
forming insulating layer patterns for insulating the second sensing electrodes and the bridge patterns from each other on the bridge patterns; and
forming the first and second sensing electrodes on the substrate where the metal conductive layer, the bridge patterns and the insulating layer patterns are formed.

16. The method as claimed in claim 15, wherein the step of forming the bridge patterns comprises:
coating a first nanowire conductive layer on the substrate; and
patterning the first nanowire conductive layer.

17. The method as claimed in claim 16, wherein the step of forming the insulating layer patterns comprises:
depositing an insulating layer on the substrate where the bridge patterns are formed; and
patterning the insulating layer.

18. The method as claimed in claim 16, wherein the step of forming the first and second sensing electrodes comprises:
coating a second nanowire conductive layer on the substrate where the metal conductive layer, the bridge patterns, and the insulating layer patterns are formed; and
patterning the second nanowire conductive layer.

19. The method as claimed in claim 18, wherein the first and second nanowire conductive layers include a material including AgNW.

20. The method as claimed in claim 18, further comprising the step of forming outside wiring lines for connecting the first and second sensing electrodes to an external driving circuit in units of lines in the non-active area.

21. The method as claimed in claim 20, wherein, in the step of forming the outside wiring lines, the metal conductive layer, the first nanowire conductive layer and the second nanowire conductive layer, which are sequentially laminated in the non-active area, are simultaneously patterned.

22. The method as claimed in claim 21, wherein the outside wiring lines are simultaneously formed with the first and second sensing electrodes through the same process.

23. A touch screen panel, comprising:
a substrate divided into an active area and a non-active area outside the active area;
first sensing electrodes connected in a first direction and second sensing electrodes connected in a second direction intersecting the first direction, the first and second sensing electrodes being in the active area;
bridge patterns for electrically connecting the first sensing electrodes in the first direction;
insulating layer patterns for insulating the second sensing electrodes and the bridge patterns from each other; and
outside wiring lines for connecting the first and second sensing electrodes to an external driving circuit in units of lines;
wherein the first and second sensing electrodes are formed on the substrate where the outside wiring lines, the bridge patterns, and the insulating layer patterns are formed.
